(19) United States
(12) Patent Application Publication
(10) Pub. No.: US 2013/0093890 A1
(43) Pub. Date: Apr. 18, 2013

(54) VEHICLE DATA COMMUNICATION AND DISPLAY SYSTEM

(71) Applicant: Thomas W. CUNNINGHAM, Orlando, FL (US)

(72) Inventor: Thomas W. CUNNINGHAM, Orlando, FL (US)

(21) Appl. No.: 13/630,177

(22) Filed: Sep. 28, 2012

Related U.S. Application Data
(60) Provisional application No. 61/546,304, filed on Oct. 12, 2011.

(51) Int. Cl. B60Q 1/00; H04N 7/18

(52) U.S. Cl. 348/148; 340/425.5; 348/E07.085

(57) ABSTRACT

A vehicle data communication and display system includes at least one display device for vehicular mounting, at least one communications device for obtaining data from at least one extra-vehicular data source and at least one electronic controller for vehicular mounting, the at least one electronic controller in signal communication with the at least one display device and the at least one communications device and operating the at least one vehicle display device based on the data obtained by the at least one communications device. The at least one communications device can obtain traffic signal information for an imminent traffic signal and the at least one electronic controller operate the at least one display device to display the traffic signal information.

### CROSS-REFERENCE TO RELATED APPLICATION

This application claims the benefit of U.S. Provisional Application Ser. No. 61/546,304, filed on Oct. 12, 2011, the contents of which are herein incorporated by reference in their entirety.

### FIELD OF THE INVENTION

The present invention relates to vehicles and information display systems employed in connection therewith.

### BACKGROUND OF THE INVENTION

The past several years have seen increased information being placed at the disposal of vehicle operators. For instance, it is now common for many cars and trucks to be equipped with global positioning system (GPS) units that can readily display a vehicle's position and directions to a desired destination. Likewise, several vehicles are offered with the option of a back-up camera and/or sensors, which can alert a driver to an otherwise unperceived hazard behind his or her vehicle. Despite the usefulness of such systems, further improvements are possible with respect to the display of data to vehicle operators.

In one example, referring to FIG. 1, a vehicle 330 is approaching an intersection behind a larger, taller vehicle 430. The vehicle 430 obscures the view of the intersection for the vehicle 330. Although the vehicle 330 may be equipped with GPS and/or a back-up camera, there is no way for the operator of the vehicle 330 to be aware of the status of the traffic signal 336 for the approaching intersection. If the vehicle 430 fails to brake, or brakes late and hard, a safety hazard may be created.

### SUMMARY OF THE INVENTION

In view of the foregoing, it is an object of the present invention to provide an improved vehicle data communication and display system. According to an embodiment of the present invention, a vehicle data communication and display system includes at least one display device for vehicular mounting, at least one communications device for obtaining data from at least one extra-vehicular data source and at least one electronic controller for vehicular mounting, the at least one electronic controller in signal communication with the display device and the communications device and operating the at least one vehicle display device based on the data obtained by the at least one communications device.

According to an aspect of the present invention, the at least one communications device obtains traffic signal information for an imminent traffic signal and the at least one electronic controller operates the at least one display device to display the traffic signal information.

According to a further aspect of the present invention, the at least one display device can include at least one interior display device for displaying the data to a vehicle occupant and at least one exterior display device for the displaying the data outside the vehicle. According to an additional aspect of the present invention, the at least one communications device transmits vehicle data to at least one extra-vehicular data repository.

These and other objects, aspects and advantages of the present invention will be better appreciated in view of the drawings and following detailed descriptions of preferred embodiments.

### BRIEF DESCRIPTION OF THE DRAWINGS

FIG. 1 is a view from the perspective of a driver of a conventional vehicle, obscured by another vehicle;

FIG. 2 is a schematic top view of a vehicle equipped with a vehicle data communication and display system, according to an embodiment of the present invention;

FIG. 2A is a front schematic view of the vehicle of FIG. 2;

FIG. 2B is a schematic rear view of the vehicle of FIG. 2; and

FIG. 3 is a view from the perspective of the driver of the vehicle of FIG. 2, toward a similarly equipped vehicle with another similarly equipped vehicle visible in a rear view mirror thereof.

### DETAILED DESCRIPTION OF PREFERRED EMBODIMENTS

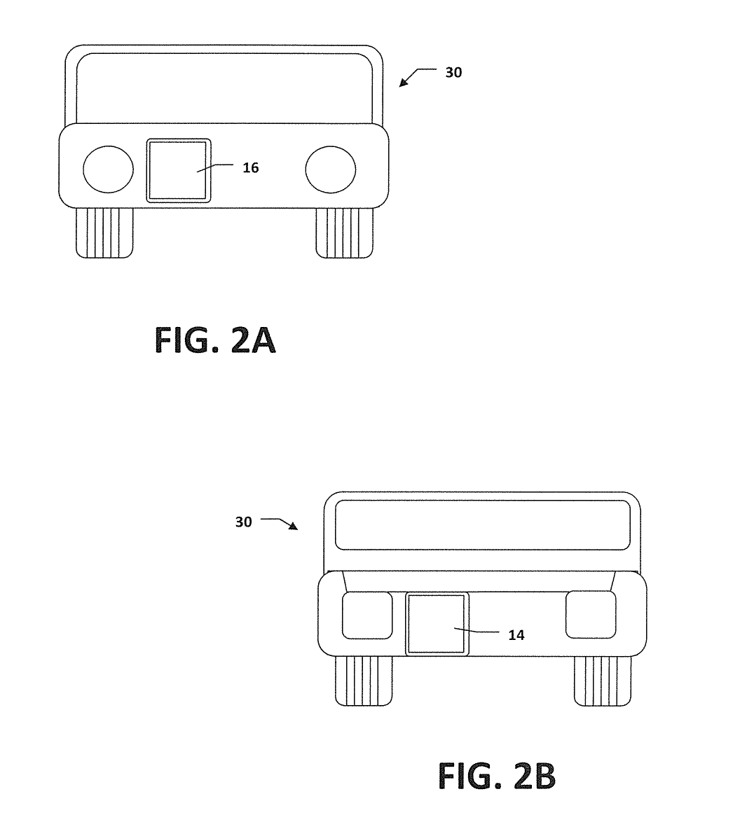

Referring to FIGS. 2-2B, according to an embodiment of the present invention, a vehicle data communication and display system 10 includes an interior display device 12, rear and front exterior display devices 14, 16, a communications device 20 and an electronic controller 22 mounted on a vehicle 30. The communications device 20 obtains data from an extra-vehicular data source 32 and operates the display devices 12, 14, 16 based on the data obtained by the communications device 20.

The display devices 12, 14, 16 are preferably low-profile flat screen-type displays—for instance, liquid crystal displays (LCDs) and/or light emitting diode displays (LEDs). Any exterior displays 14, 16 should be suitably weather-resistant or housed in suitable enclosures. The present invention is not necessarily limited to any particular type, configuration, size, shape and number of displays. For example, embodiments of the system 10 could incorporate only one or more interior displays and/or only one or more exterior displays. In one advantageous embodiment, the system could include only an interior display and a rear exterior display. Besides the front and rear of the vehicle, exterior displays could be placed at other vantage points on the vehicle's exterior, as desired, and multiple displays could be located on a single side—e.g., two separate display panels on the vehicle rear side. Additionally, display devices need not provide an exclusively visual display, but could also incorporate audible and/or other sensible signals, as well.

The communications device 20 can, in the broadest sense, include at least one electronic device adapted to obtain data from an extra-vehicular source 32. However, the communications device 20 can advantageously also receive intra-vehicular data from the vehicle and also transmit data to an extra-vehicular information repository—which could be the same as, or distinct from one or more of the sources 32. For example, in an advantageous embodiment, the communications device 20 includes a transceiver that is adapted to wirelessly receive and transmit data. The communications device 20 could also include one or more digital cameras that are adapted to recognize and image some portion of the environment around the vehicle. Additionally, the communications device 20 could include a data port—for instance, a universal serial bus (USB) port or other disk drive or data connection through which data can be uploaded to the electronic controller 22.

The electronic controller 22 includes at least one processor capable of executing program instructions stored in machine readable memory. The present invention is not necessarily limited to any particular number, type or configuration of processors or to any particular format or amount of machine readable memory, programming language or the like. For example, various functions of the electronic controller 22 could be accomplished by multiple processors connected via one or more data networks. Moreover, the electronic controller 22 is not necessarily a physically separate component of the system, but could be integrated into one or more other components—for example, the electronic controller 22 could be integrated into a display device or communications device.

The system 10 of the present invention can be applied to any vehicle 30. As used herein, the term “vehicle” generally refers to any mobile structure used to transport people and/or materials from one location to another. For example, motorized and non-motorized vehicles, including motorcycles, cars, sport-utility vehicles (SUVs), vans, trucks, buses, trailers, etc., could all beneficially employ one or more aspects of the present invention. Additionally, certain aspects of the present invention could also be employed on non-road vehicles, such as boats or trains and/or other means of transportation.

Also, a plurality of extra-vehicular data sources 30 (and/or repositories) could be utilized. Advantageous, but non-exclusive, examples include traffic light systems. As used herein, information from a traffic light system is referred to generally as “traffic signal information” and can refer to a wide variety of information associated to the current color/condition of an imminent traffic signal, time until the next change in the traffic signal and the like.

Particularly advantageous operations of the system 10 in connection with traffic signal systems will be described in further detail below. It will be appreciated that the present invention is not necessarily limited to this example, but could be advantageously applied in other situations in which other types of vehicle operational information is received and displayed by the system 10, in addition to or instead of traffic signal information. As used herein, “vehicle operational information” generally includes information that relates, like the condition of imminent traffic signals, to the proper operation of the vehicle being operated—as distinct from advertisements or other dynamic or static media content that might be displayed but is unrelated to the operational condition of the vehicle.

### Operations with Traffic Signal Systems

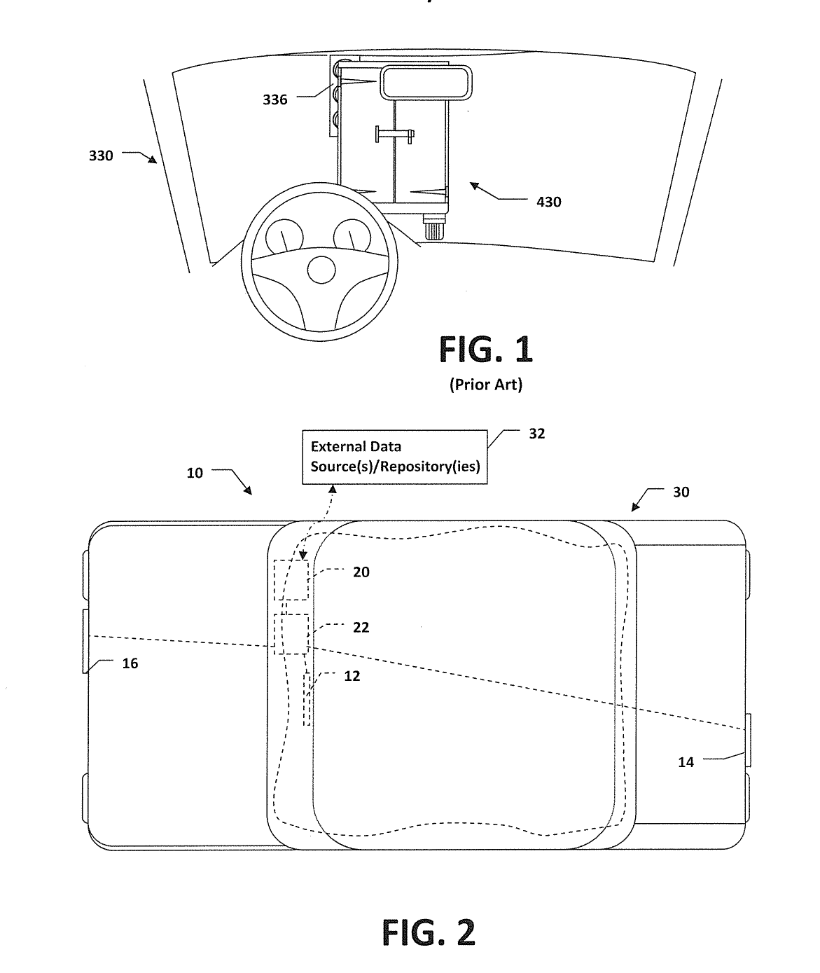

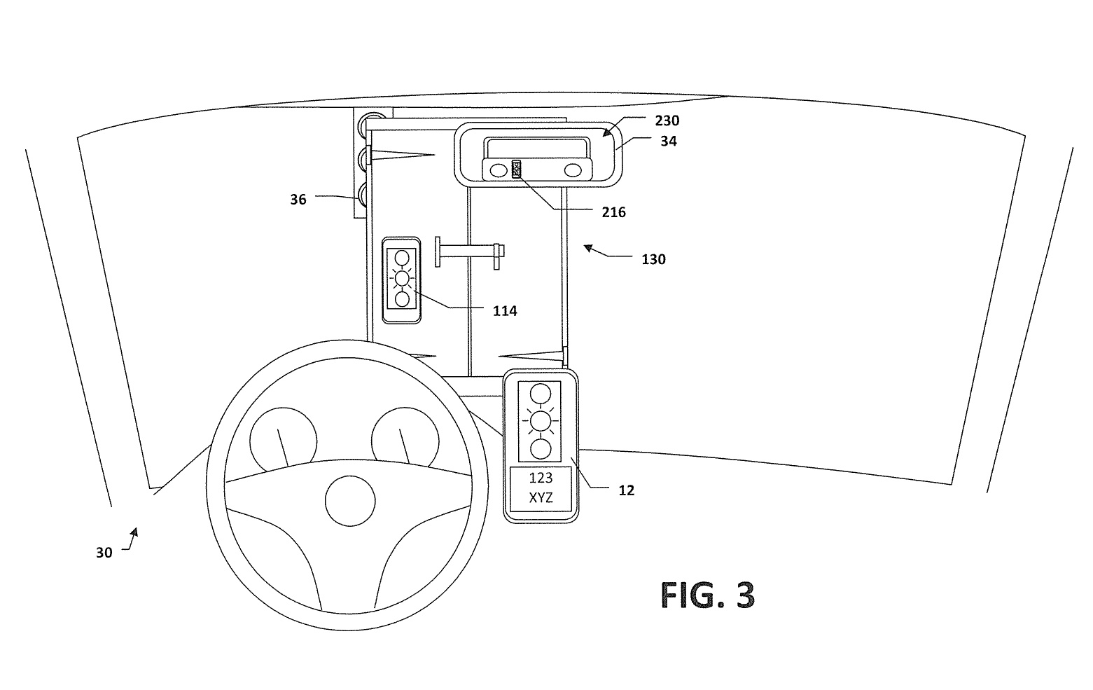

Referring to FIG. 3, a scenario similar to FIG. 1 is depicted in which the view of an intersection from the vehicle 30 is wholly or partially obscured by another vehicle 130. Thus, an operator of the vehicle 30 is prevented from seeing the condition of an imminent traffic signal 36. As used herein, the “imminent” traffic signal is the next traffic signal applicable to the vehicle 30 as it moves in its direction of travel. Certain thresholds could be applied with respect to imminence, such that the system 10 will not alert a vehicle operator to a traffic signal which may be the next one for that vehicle but is still several miles distant (additionally, the physical distance and/or estimated time to reach the signal could also be displayed on one or more of the display devices 12, 14, 16).

In an advantageous application of the invention, the imminent traffic signal is connected to a traffic signal system 32 with which the communications device 20 is able to wirelessly communicate. Part of this communication with the traffic signal system can include a determination of which traffic signal is, in fact, imminent—for instance using positioning data derived from a GPS receiver (another possible element of communications device 20) of the vehicle 30 and traffic system layout information possessed by the traffic signal system.

Regardless of how the determination is made, the condition of the imminent traffic signal is displayed on one or more of the display devices 12, 14, 16—and in this particular example, at least on the interior display device 12. Thus, the operator of the vehicle 30 is alerted to the traffic signal status even if the actual line of sight to the signal is obscured—although it will be appreciated that such information would be useful even where the line of sight was not obscured; for example, to alert a driver whose attention may be focused elsewhere.

The present inventor is also the inventor of U.S. Non-Provisional Application Ser. No. 13/311,093, filed on Dec. 5, 2011, relating to advanced traffic signals and traffic signal systems—the contents of which application are herein incorporated by reference in their entirety. The display devices 12, 14, 16 can advantageously be operated to display all of the traffic signal information disclosed therein, and in the same configurations. For example, one or more display devices 12, 14, 16 can include a section displaying a visual representation of the condition/color of the imminent traffic signal, and another section displaying a countdown of time (preferably in seconds and/or minutes and seconds) until the next change in condition/color.

However, the system 10 is not limited to working in connection with such an advanced system, and can even be employed in traffic signal applications where the traffic signal system is incapable of actively communicating its status. For example, the communications device 20 can include a camera that optically searches for an imminent traffic signal, and upon detection of one, that optically-derived data can be used to operate one or more of the display devices 12, 14, 16.

From FIG. 3, the benefit to other vehicles of a vehicle data communication and display system 10 (as well as a supplementary benefit to the vehicle employing such a system) is also apparent. In FIG. 3, the leading vehicle 130 is also equipped with such a system including a rear display 114. The traffic signal information is displayed by the rear display 114 to the following vehicle 30, such that the operator of the vehicle 30 is provided with an indication (or an additional indication) of the imminent traffic signal condition, whether or not his or her own vehicle is similarly equipped. Similarly, the front of a following vehicle 230 can be seen via a rear view mirror 34. The following vehicle 230 is equipped with a forward display 216 visible in the mirror 34. Advantageously, a forward display can show direction-sensitive characters (such as letters or numbers) in mirror-image, alternatively or in addition to, their normal orientation to facilitate viewing in a mirror.

If, as in the current example, the vehicle 30 is equipped with the system 10, the rear display 114 (and/or 216) can be imaged by a camera element of the communications device 20 to provide another data source for traffic signal communication. Alternately, or in addition to, such a communications means, two similarly equipped vehicles can communicate information wirelessly. It will be readily appreciated that a large number of similarly equipped vehicles approaching a traffic signal controlled intersection will allow traffic signal information to be relayed to all vehicles regardless of differing vehicles heights or line of sight issues.

In addition to traffic signal condition, the system 10 can be used to alert vehicle operators to other traffic-related conditions that may not (depending on the capabilities of the traffic signal system) be displayed by a traffic signal. For example, an indication of a pending accident, emergency condition, road closure or the like could be displayed.

The foregoing embodiments and examples are provided for illustrative and enablement purposes; those skilled in the art will appreciate that the present invention is not necessarily limited thereto. For example, additional modifications, combinations and sub-combinations of illustrated elements, as well as adaptations to particular circumstances, will fall within the scope of the invention herein shown and described and of the claims appended hereto.

What is claimed is:

1. A vehicle data communication and display system comprising:
at least one display device for vehicular mounting;
at least one communications device for obtaining data from at least one extra-vehicular data source; and
at least one electronic controller for vehicular mounting, the at least one electronic controller in signal communication with the at least one display device and the at least one communications device and operating the at least one display device based on the data obtained by the at least one communications device.

2. The system of claim 1, wherein the data displayed on the at least one display device based on the data obtained from the at least one extra-vehicular data source includes vehicle operational information.

3. The system of claim 1, further comprising the vehicle.

4. The system of claim 3, wherein the at least one display device includes at least one interior display device.

5. The system of claim 3, wherein the at least one display device includes at least one exterior display device.

6. The system of claim 3, wherein the at least one display device includes at least one interior display device and at least one exterior display device.

7. The system of claim 6, wherein the at least one exterior display device is located on a rear side of the vehicle.

8. The system of claim 7, wherein the at least one exterior display device includes another display device located on a front side of the vehicle.

9. The system of claim 1, wherein the at least one communications device includes a receiver for wirelessly receiving the data from the at least one extra-vehicular data source.

10. The system of claim 9, wherein the receiver is part of a transceiver and the at least one electronic controller is further configured to operate the transceiver to wirelessly transmit information from the vehicle.

11. The system of claim 1, wherein the at least one communications device includes a digital camera for imaging at least a portion of an environment surrounding the vehicle.

12. The system of claim 1, wherein the at least one communications device is configured to obtain traffic signal information for an imminent traffic signal and the at least one electronic controller operates the at least one display device based on the traffic signal information.

13. The system of claim 12, wherein the at least one communications device includes a receiver for wirelessly receiving the traffic signal information from a traffic signal system.

14. The system of claim 13, wherein the receiver is part of a transceiver and the at least one electronic controller is further configured to operate the transceiver to wirelessly transmit information from the vehicle.

15. The system of claim 12, wherein the at least one electronic controller operates the at least one display device to display a condition of the imminent traffic signal.

16. The system of claim 12, wherein the at least one communications device is configured to obtain the traffic signal information by recognizing and imaging at least one of a traffic signal or a representation of a traffic signal using a digital camera.

17. The system of claim 12, further comprising the vehicle and wherein the traffic signal information is displayed on at least one interior display.

18. The system of claim 12, further comprising the vehicle and wherein the traffic signal information is displayed on at least one exterior display.

19. The system of claim 12, further comprising the vehicle and wherein the traffic signal information is displayed on at least one interior and at least one exterior display.

20. The system of claim 19, wherein the at least one exterior display is located on a rear side of the vehicle.

21. The system of claim 20, wherein the at least one exterior display includes another exterior display located on a front side of the vehicle.

22. The system of claim 12, wherein the at least one electronic controller also operates the at least one display device to display a time until the next change in condition of the imminent traffic signal.
